(19) United States
(12) Patent Application Publication
(10) Pub. No.: US 2003/0078898 A1
(43) Pub. Date: Apr. 24, 2003

(54) CHARGING SYSTEM, APPARATUS FOR DECIDING A UNIT CHARGE, APPARATUS FOR DISPLAYING A UNIT CHARGE, CIRCUIT CONTROL APPARATUS AND ACCESS CONTROL APPARATUS

(75) Inventors: HAJIME NAKAMURA, TOKYO (JP); HIROYUKI YOKOYAMA, TOKYO (JP); TOSHIKANE ODA, TOKYO (JP)

Correspondence Address: BIRCH STEWART KOLASCH & BIRCH, PO BOX 747, FALLS CHURCH, VA, 22040-0747, US

(73) Assignee: CHARLES GORENSTEIN

(21) Appl. No.: 09/174,009

(22) Filed: Oct. 16, 1998

(30) Foreign Application Priority Data
Oct. 16, 1997 (JP) 9-283289

(51) Int. Cl. G06F 17/00; G06G 7/00

(52) U.S. Cl. 705/400

(57) ABSTRACT

A unit charge is set and varied in course of time by the unit charge decision apparatus 12. A new unit charge is notified, via the circuit 2, to the display 8 at the user's home 6 by the unit charge notification apparatus 13. A communication charge is calculated by using the notified unit charge. At this time, the monitor 11 monitors, after notifying the unit charge, a state of use of the service facilities and the history database 15 records a correlation between the unit charge already notified to the user and the monitored state of use of the service facilities after having notified the unit charge. The unit charge decision apparatus 12 decides the new unit charge based on the correlation between the unit charge already notified to the user and the state of use of the service facilities after having notified the unit charge by using the recorded history data.

### FIELD OF THE INVENTION

This invention relates to a charging system, an apparatus for deciding a unit charge, an apparatus for displaying a unit charge and a circuit control apparatus respectively regarding a use of a communication network facilities. Further, this invention relates to a charging system, an apparatus for deciding a unit charge, an apparatus for displaying a unit charge and an access control apparatus respectively regarding a use of a service facilities for providing information.

### BACKGROUND

In a prior art of a communication network system, when a charging system charges a charge for using a communication network facilities by a meter-rate system, a unit charge is previously set corresponding to a day of the week and/or a time zone. Hereafter, a charge for using the communication network facilities is called as a communication charge.

Generally, a unit charge, corresponding to a day of the week or a time zone at which a quantity of is small, is set lower than that corresponding to a day of a week or a time zone at which a quantity of communication is large. The reason for above-mentioned setting of the unit charge is to awaken user's communication demand by decreasing the unit charge and then to effectively utilize the communication network facilities which is not used.

However, there are following weak points (1) and (2) in the prior art because the unit charge is previously set every day of the week or every time zone.

(1) When an unexpected decrease in a communication demand occurs, it is impossible to awaken an amount of a communication demand by immediately decreasing the unit charge.

(2) Further, if the unit charge is sufficiently decreased, it is impossible to awaken an amount of a communication demand. In contrast to this, if the unit charge is excessively decreased, a quality of communication service becomes worse because of a larger communication demand than a capacity of the communication network facilities.

There are also same week points in a case of charging a charge for using a service facilities for providing information such as an access to computer server system, if its unit charge is previously set every day of the week or every time zone. Hereafter, a charge for using the service facilities is called as a service charge.

### SUMMARY OF THE INVENTION

First object of the present invention is to provide a charging system, an apparatus for deciding a unit charge, an apparatus for displaying a unit charge and a circuit control apparatus which respectively enable to stabilize a service quality of communication and earings, by setting a unit charge pertinent to a communication service of which prediction of an amount of demand is difficult and/or a communication service of which demand largely fluctuates in course of time, and then by always awaking the amount of the communication demand corresponding to a capacity of the communication network facilities.

Second object of the present invention is to provide a charging system, an apparatus for deciding a-unit charge, an apparatus for displaying a unit charge and an access control apparatus which respectively enable to stabilize a service quality for providing information and earings, by setting a unit charge pertinent to a service of which prediction of an amount of demand is difficult and and for a service of which demand largely fluctuates in course of time, and then by always awaking the amount of the access demand corresponding to a capacity of the service facilities.

In a preferred embodiment, the present invention is directed to a charging system comprising:

first means for notifying, via a communication circuit, a subscriber of a unit charge which is varied in course of time and for charging a communication charge which is a charge for using a communication network facilities based on said unit charge notified to the subscriber;

second means for monitoring, after notifying said unit charge, a state of use of the communication network facilities;

third means for recording a correlation between said unit charge already notified to the subscriber and said state of use of the communication network facilities after having notified said unit charge; and

fourth means for deciding a new unit charge based on said correlation between the unit charge already notified to the subscriber and the state of use of the communication network facilities after having notified the unit charge.

In a further preferred embodiment, the present invention is directed to an apparatus which is used by the above-mentioned charging system in the communication network facilities, wherein said apparatus decides a unit charge by using time-series data of said unit charge already notified to the subscriber, time-series data of said state of use of the communication network facilities and correlation data between the unit charge already notified to the subscriber and the state of use of the communication network facilities after having notified the unit charge.

In a still further preferred embodiment, the present invention is directed to an apparatus which is connected with above-mentioned communication network facilities having said charging system, wherein said apparatus is notified said unit charge from said charging system and displays said notified unit charge.

In a more further preferred embodiment, the present invention is directed to a circuit control apparatus which is connected with above-mentioned communication network facilities having said charging system, wherein said circuit control apparatus is notified said unit charge from said charging system and performs a setting and an open of a communication circuit between a communication terminal and said communication network facilities based on said unit charge notified from said charging system.

In another preferred embodiment, the present invention is directed to a charging system comprising:

first means for notifying, via a communication circuit, a user of a unit charge which is varied in course of time and for charging a service charge which is a charge for using a service facilities for providing information based on said unit charge notified to the user;

second means for monitoring, after notifying said unit charge, a state of use of the service facilities;

third means for recording a correlation between said unit charge already notified to the user and said state of use of the service facilities after having notified said unit charge; and

fourth means for deciding a new unit charge based on said correlation between the unit charge already notified to the user and the state of use of the service facilities after having notified the unit charge.

In still another preferred embodiment, the present invention is directed to an apparatus which is used by the above-mentioned charging system in the service facilities, wherein said apparatus decides a unit charge by using time-series data of said unit charge already notified to the user, time-series data of said state of use of the service facilities and correlation data between the unit charge already notified to the user and the state of use of the service facilities after having notified the unit charge.

In more another preferred embodiment, the present invention is directed to an apparatus which is connected with the above-mentioned service facilities having said charging system, wherein said apparatus is notified said unit charge from said charging system and displays said notified unit charge.

In still more another preferred embodiment, the present invention is directed to an access control apparatus which is connected with the above-mentioned service facilities having said charging system, wherein said access control apparatus is notified said unit charge from said charging system and controls an access to said service facilities from a communication terminal based on said unit charge notified from said charging system.

These and other objects of the present application will become more readily apparent from the detailed description given hereafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings which are given by way of illustration only and wherein:

FIG. 1 is a connection diagram of a local exchange station and a subscriber's home for indicating a charging system as a first embodiment of the present invention.

FIG. 2 shows a functional configuration of an apparatus for deciding a unit charge as a second embodiment of the present invention.

FIG. 3 is a connection diagram of a local exchange station and a subscriber's home for indicating functional configuration of a circuit control apparatus as a third embodiment of the present invention.

FIG. 4 is a connection diagram of a service facilities for providing information and a user's home for showing a charging system as a fourth embodiment of the present invention.

FIG. 5 shows a functional configuration of an apparatus for deciding a unit charge as a fifth embodiment of the present invention.

FIG. 6 is a connection diagram of a service facilities for providing information and a user's home for indicating functional configuration of an access control apparatus as a sixth embodiment of the present invention.

### DESCRIPTION OF THE PREFERRED EMBODIMENT

### First Embodiment

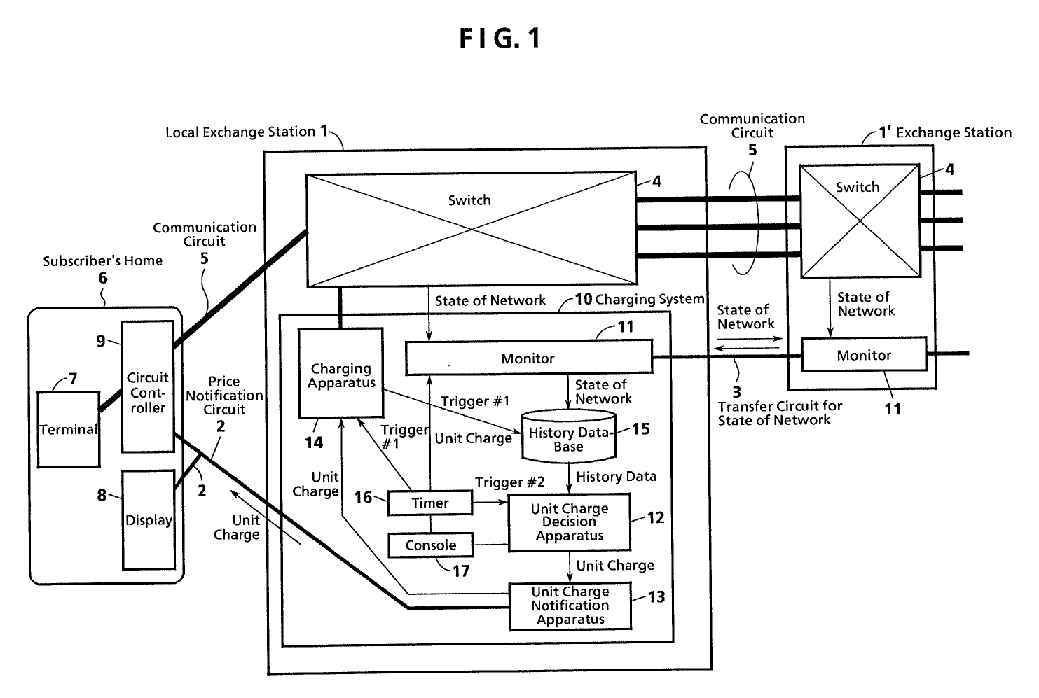

Referring to FIG. 1, as a first embodiment of the present invention, a charging system, regarding a telecommunication service, will be explained. FIG. 1 shows an example of a local exchange station which constructs a telecommunication network and to which a charging system of the present invention applied.

In FIG. 1, 1 denotes a local exchange station for receiving subscribers, 1′ denotes an exchange station connected with the local exchange station 1, 2 denotes a price notification circuit, 3 denotes a transfer circuit for a state of a communication network, 4 denotes a switch or an exchange, 5 denotes a telecommunication circuit, 6 denotes a subscriber's home, 7 denotes a telecommunication terminal, 8 denotes a unit charge display apparatus, 9 denotes a circuit control apparatus, 10 denotes a charging system. The charging system 10 includes a monitor 11 for monitoring the state of the telecommunication network, an apparatus 12 for deciding a unit charge, an apparatus 13 for notifying the unit charge, a charging apparatus 14 and a history database 15. Further, 16 denotes a timer and 17 denotes a console.

The switch 4 and the charging system 10 are provided with the local exchange station 1. The switch 4 is connected with the monitor 11 and the charging apparatus 14 respectively in the charging system 10. Also in the exchange station 1′, there are the switch 4 and the monitor 11 connected with the switch 4. The telecommunication terminal 7 is provided with the subscriber's home 6. One of the display 8 and the circuit controller 9 is provided with the subscriber's home 6, or, both of the display 8 and the circuit controller 9 are provided with the subscriber's home 6. The circuit controller 9 is connected with the terminal 7.

There are the price notification circuit 2 and the telecommunication circuit 5 between the subscriber's home and the local exchange station 1. While these circuits 2 and 5 are logically separated each other, it is possible to use a physically same transmission line in common. Further, there are the transfer circuit 3 for the state of the network and the telecommunication circuit 5 between the local exchange station 1 and the exchange station 1′. While these circuits 1 and 1′ are logically separated each other, it is possible to use a physically same transmission line in common.

The display 8 and the circuit controller 9 at the subscriber's home are connected with the unit charge notification apparatus 13 in the charging system 10 via the price notification circuit 2. The terminal 7 is connected with the switch 4 in the local exchange station 1 via the circuit controller 9 and the telecommunication circuit 5. The switch 4 in the local exchange station 1 is connected with the switch 4 in the exchange 1′. The monitor 11 in the charging system 10 is connected with the monitor 11 in the exchange station 1′ via the transfer circuit 3 for the state of the network.

The monitor 11 has a function for collecting, in real time, data which indicate the state of the communication network. The monitor 11 gives the collected data to the history database 15. Wherein, examples of the state of the network are a state of some congestion in the switch 4 and a state of use of a communication facilities etc.

The state of the network is varied by the following factors.

(1) a capacity of the switch 4

(2) an amount of use in the communication circuit 5 between the local exchange station 1 and the exchange station 1′

(3) a connection and an opening of the communication circuit 5

(4) a transmission speed and a communication quality of the circuit 5 in connection

(5) a change of a service classification

The transfer circuit 3 is used for mutually sending and receiving the collected data indicating the state of network between the monitor 11 in the local exchange station 1 and the monitor 11 in the exchange station 1′. A transfer circuit is also used for sending and receiving the data indication the state of the network, in a case that a center, for centrally monitoring the state of the network, is provided.

The apparatus 12 decides, in real time, a unit charge pertinent to the state of the network based on the data indicating the state of the network. Namely, the apparatus 12 decides, in real time, the unit charge which is judged as a most pertinent value in the state of the network, based on the data indicating the state of the network collected by the monitor 11, parameters of various kinds determined by a manager of the communication network and the history data indicating a correlation between the unit charge already notified to the subscriber and the state of the communication network after having notified the unit charge. The decision of the unit charge is periodically performed and then the unit charge is changed in course of time.

The history database 15 stores and holds the history data i.e. the correlation between the unit charge already notified to the subscriber and the state of the communication network after having notified the unit charge. The unit charge notified to the subscriber is given to the database 15 from the charging apparatus 14 and the state of the communication network after having notified the unit charge is given to the database 15 from the monitor 11.

The apparatus 13 has a function for sending, in real time, the unit charge decided by the apparatus 12 to the charging apparatus 14 and a function for notifying, in real time, the unit charge decided by the apparatus 12 to the display 8 and the circuit controller 9 at the subscriber's home 6 via the price notification circuit 2. The charging apparatus 14 has a function for charging a communication charge by using the transferred unit charge which varies in real time. The display 8 displays, always or according to a request of the subscriber, the unit charge notified from the notification apparatus 13.

According to the unit charge notified from the apparatus 13 in the charging system 10, the circuit controller 9 automatically performs a setting and an opening of the communication circuit 5 between the terminal 7 and the switch 4 in the local exchange station 1. The setting of the circuit 5 includes a selection of a communication quality and a service classification.

The charging system 10 will be explained in detail including its initial value setting, the timer 16 and the console 17.

First, an operator of the communication network sets an initial value of the unit charge in various communication services and a guide line for a decision of the unit charge to the unit charge decision apparatus 12 by using the console 17. While it is necessary to perform these setting before start of the charging system 10, it is possible to change the setting after start of the system 10.

The unit charge decision apparatus 12 notifies the initial unit charge set by the operator to the unit charge notification apparatus 13. The apparatus 13 notifies the received initial unit charge to the charging apparatus 14 and the subscriber's home 6. The charging apparatus 14 starts to charge by using the received unit charge.

On the other hand, at the subscriber's home, the display 8 displays the notified unit charge for various kinds of a communication service. Therefor, the subscriber can look at the displayed unit charge on the display 8, then can communicates by using the communication circuit 5 and the switch 4 in the network after performing a selection of a service classification and/ or an adjustment of an amount of communication according to his and/or her demand.

As another case, in the subscriber's home 6, the circuit controller 9 automatically performs the setting and the opening of the communication circuit 5 after automatically performing a selection of a communication quality and a selection of a service classification and/or an adjustment of an amount of communication according to the notified unit charge. Namely, the communication is automatically performed by using the communication circuit 5 and/or the switch 4 of the network.

The monitor 11 monitors, in real time, the state of congestion in the switch 4 and the used capacity of the communication circuit 5. A result of monitoring is mutually transferred, as data of the state of the network, among the monitors 11.

The monitor 11 receives a trigger #1 from the timer 16. When the monitor 11 receives the trigger #1, the monitor 11 records the data indicating the state of the network which was collected during a period F1 before receiving the trigger #1 in the history database 15. The timer 16 also sends the trigger #1 to the charging apparatus 14 at the same time when the timer 16 sends the trigger #1 to the monitor 11.

When the charging apparatus 14 receives the trigger #1, the apparatus 14 records the unit charge which was used during a period F1 before receiving the trigger #1 in the history database 15.

As the result, the history database 15 holds the data indicating the state of the network and the unit charge respectively recorded during the period F1.

Furthermore, the timer 16 periodically sends a trigger #2 by a period F2 to the apparatus 12 for deciding the unit charge. When the apparatus 12 receives the trigger #2, the apparatus 12 downloads or reads the data indicating the state of the network and the unit charge respectively recorded in the database 15 as the history data, and then decides a new unit charge in real time by using the history data. In detail of the decision of the new unit charge, the apparatus 12 predicts the user's elasticity of communication demand depending on a cost, based on the correlation between the data indicating the state of the network and the past unit charge respectively recorded as the history data. The apparatus 12 decides, by using the result of the prediction, the new unit charge which enables to estimate an occurrence of an amount of communication demand pertinent to the capacity of the communication network facilities.

The new unit charge decided by the apparatus 12 is transferred to the price notification apparatus 13, then the apparatus 13 immediately notifies the new unit charge to the charging apparatus 14 and the subscriber's home 6.

The charging apparatus 14 starts to charge by using the notified new unit charge. In detail, because it is necessary to use a unit charge which has been recognized by the subscriber, the charging apparatus 14 changes a unit charge to be used to the new unit charge at a timing which is set by considering a time delay required to notify the new unit charge to the subscriber.

By repeating the above-mentioned process, the unit charge is periodically varied and set to the value pertinent to an amount of the communication demand, therefor an amount of the communication demand pertinent to the capacity of the facilities is applied to the communication network.

The period F1 and the period F2 are set by the operator of the communication network by using the console 17. Basically, the period F1 and the period F2 are set as F1≦F2. It is possible to change, always such as during an operation of the charging system 10, each value of the period F1 and the period F2.

Further, it is possible that the monitor 11, instead of the timer 16, sends the trigger #1 and the trigger #2 according to some content of the data indicating the state of the network. In this case, it is desirable to construct the communication system so that the operator of the communication network can send the trigger #1 and the trigger #2 when the data indicating the state of the network becomes to a certain specific state. It is also possible to use both of the trigger sent from the timer 16 and the trigger sent from the monitor 11.

### Second Embodiment

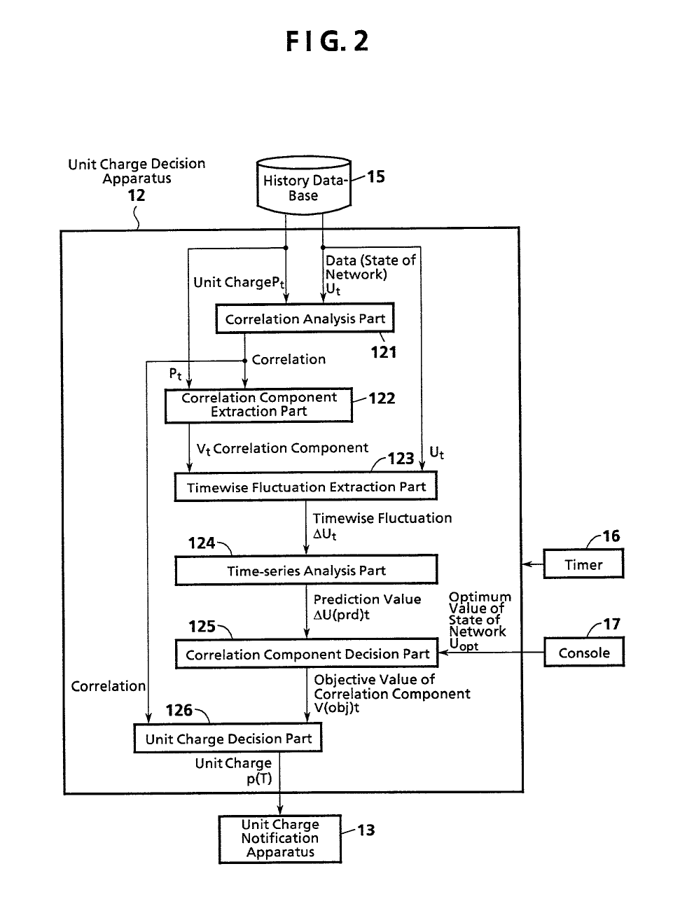

Referring to FIG. 2, as a second embodiment of the present invention, an example of the unit charge decision apparatus or the apparatus for deciding the unit charge which is used the charging system regarding the telecommunication service, will be explained. FIG. 2 shows an example of a functional configuration of the unit charge decision apparatus. It is assumed that the unit charge decision apparatus shown in FIG. 2 is used in the charging system 10 shown in FIG. 1.

In FIG. 2, the unit charge decision apparatus 12 comprises: a correlation analysis part 121; a correlation component extraction part 122; a timewise fluctuation extraction part 123; a time-series analysis part 124; a correlation component decision part 125; and a unit charge decision part 126.

In this embodiment, it is assumed that the trigger #2 shown in FIG. 1 is periodically sent from the timer 16 to the apparatus 12 for deciding the unit charge. In the case that the trigger #2 is sent from the monitor 11, while an interval of the trigger is not uniform, the basic operation is same to the above.

In FIG. 2, the timer 16 periodically sends the trigger #2 in the period F2 to the apparatus 12 for deciding the unit charge. Further, it is assumed a condition that the T-th trigger #2 has been sent to the apparatus 12. Namely, it is assumed that a time of F2×T has lapsed after the apparatus 12 started its operation.

In the apparatus 12, when the trigger #2 is received, the part 121 downloads the history data from the history database 15 for analyzing a correlation for the data indicating the state of the communication network and the unit charge. The data to be downloaded are a time-series data of the unit charge and a time-series data of the data indicating the state of the communication network respectively recorded every period F1 during the time of F2×T after the start of the charging system 10. Wherein, Pt represents the unit charge recorded according to the t-th trigger #1 and Ut represents the data indicating the state of the network recorded according to the t-th trigger #1. Further, the history data downloaded according to the T-th trigger #2 includes the unit charge Pt and the data Ut, wherein all of t satisfies the following formula.

0<F1×t<F2×T

The part 121 has a function for performing a correlation analysis between the unit charge Pt and the data Ut regarding all of t and for obtaining a correlation between the unit charge Pt and the data Ut.

The part 122 has a function for extracting, based on the correlation obtained by the part 121, a correlation component Vt of the data Ut against the unit charge Pt regarding all of t.

The part 123 has a function for extracting a timewise fluctuation component ΔUt or a fluctuation component ΔUt in course of time by subtracting the correlation component Vt from the data Ut regarding all of t.

The part 124 has a function for predicting a timewise fluctuation component ΔUt, which will occurs until the timer 16 will send the next (T+1)-th trigger #2, by performing a time-series analysis of the timewise fluctuation component. Namely, when a prediction value of ΔUt is assumed as ΔU(prd)t, the part 124 has a function for obtaining the prediction value ΔU(prd)t of the timewise fluctuation component regarding all of t which satisfies the following formula.

F2×T≦F1×t<F2 ×(T+1)

The part 125 has a function for deciding an object value V(obj)t by deleting the prediction value ΔU(prd)t from an optimum value Vopt of the data indicating the state of the communication network regarding all of t which satisfies the following formula.

F2×T≦F1×t<F2×(T+1)

The optimum value Vopt represents an ideal state of the communication network pertinent to the capacity of the communication network facilities. The operator of the network sets the optimum value Vopt by using the console 17, wherein the setting of the optimum value Vopt can be changed, always such as during the operation of the charging system 10, by using the console 17.

As the result, if the timewise fluctuation component ΔUt coincides with its prediction value ΔU(prd)t, the data Ut indicating the state of the communication network becomes the ideal correlation component Vt which realizes the optimum value Vopt.

The part 126 has a function for deciding, based on the correlation between the data Ut and the data Pt obtained by the correlation analysis part 121, the unit charge P(T) to be used until receiving the (T+1)-th trigger #2 from the object value V(obj)t regarding all of t which satisfies the following formula.

F2×T≦F1×t<F2×(T+1)

The unit charge P(T) is sent from the unit charge decision apparatus 12 to the unit charge notification apparatus 13. Further, the unit charge P(T) is notified to the charging apparatus 14 and the subscriber's home 6 by the unit charge notification apparatus 13.

According to above-mentioned process of each of the functional parts 121 to 126, it is possible for the unit charge decision apparatus 12 to periodically change the unit charge in real time or in course of time and to set the unit charge as the value which enables to awaken the amount of the communication demand pertinent to the capacity of the communication network.

### Third Embodiment

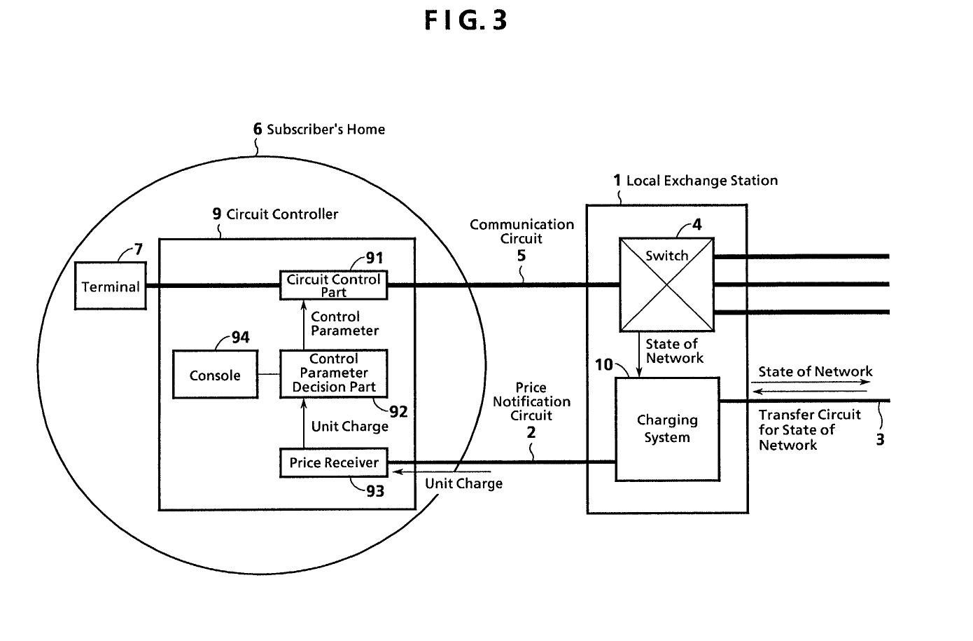

Referring to FIG. 3, as a third embodiment of the present invention, an example of the circuit control apparatus or the circuit controller regarding the telecommunication service, will be explained. FIG. 3 shows an example of a functional configuration of the circuit control apparatus.

As shown in FIG. 3, the circuit control apparatus 9 comprises: a circuit control part 91; a control parameter decision part 92; a price receiving part 93; and a console part 94.

In FIG. 3, the new unit charge is periodically notified to the price receiver 93, via the price notification circuit 2, from the charging system 10. The receiver 93 has a function for receiving the notified unit charge and a function for transferring the received unit charge to the control parameter decision part 92.

The control parameter decision part 92 has a function for deciding various kinds of parameters of the communication circuit 5 based on the notified unit charge and a function for transferring the decided parameter value to the circuit control part 91. As the parameter to be decided, there are a setting of the communication circuit, a judgment of open of the communication circuit, a transmission speed, a service quality of the communication circuit and a service classification etc.

The subscriber previously sets steps for deciding the various parameters based on the unit charge by using the console 94. The setting of these parameter can be changed, always such as during the operation of the charging system 10, by using the console 94.

The circuit control part 91 has a function for performing a change and/or an adjustment of the speed of the communication circuit 5 to be used by the terminal 7, the service quality of the communication and the service classification respectively according to the received parameter values and further has a function for performing the setting and the open of the communication circuit 5 respectively according to the received parameter values.

According to above-mentioned process of each of the functional parts 91 to 94, the circuit control apparatus 9 automatically enables to use the communication circuit 5 in a manner desired by the subscriber, for example to economically use the communication circuit 5, by controlling the communication circuit 5 according to the notified unit charge based on a control guide line previously set by the subscriber.

### Fourth Embodiment

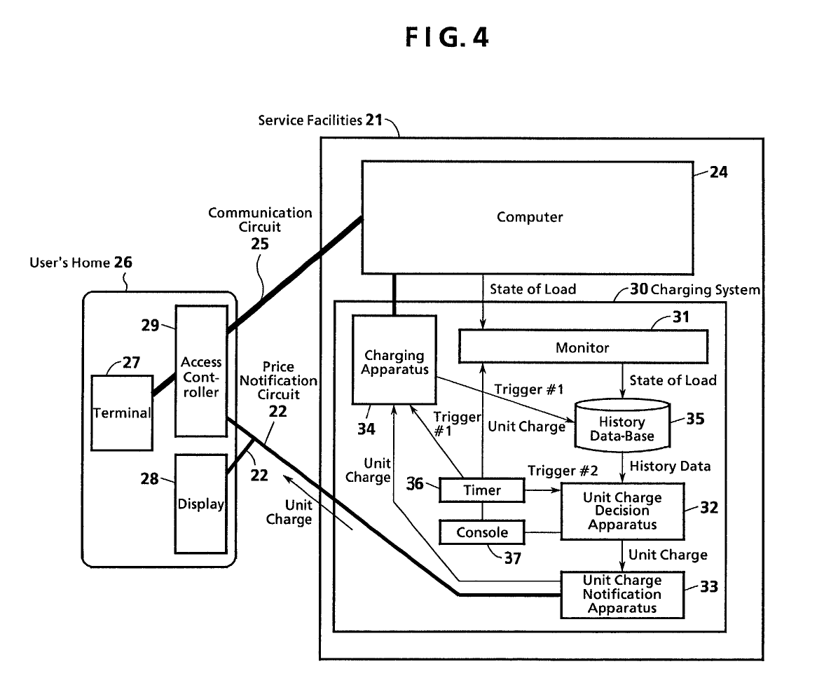

Referring to FIG. 4, as a fourth embodiment of the present invention, a charging system, regarding a service facilities for providing information such as a calculation server, will be explained. FIG. 4 shows an example of a service facilities for providing information to which a charging system of the present invention applied.

In FIG. 4, 21 denotes a service facilities for providing information, 22 denotes a price notification circuit, 24 denotes a computer, 25 denotes a telecommunication circuit, 26 denotes a user's home, 27 denotes a telecommunication terminal, 28 denotes a unit charge display apparatus, 29 denotes an access control apparatus, 30 denotes a charging system. The charging system 30 includes a monitor 31 for monitoring the load of the service facilities, an apparatus 32 for deciding a unit charge, an apparatus 33 for notifying the unit charge, a charging apparatus 34 and a history database 35. Further, 36 denotes a timer and 37 denotes a console.

The service facilities 21 provides some information to the user according to an access to the computer 24, by using the computer 24 as a server for providing a service of information. There are the monitor 31 and the charging apparatus 24 respectively connected with the computer 24. The telecommunication terminal 7 is provided with the use s home 26. One of the display 28 and the access controller 29 is provided with the user's home 26, or, both of the display 28 and the access controller 29 are provided with the user's home 26. The access controller 29 is connected with the terminal 27.

There are the price notification circuit 22 and the telecommunication circuit 25 between the user's home 26 and the service facilities 21. While these circuits 22 and 25 are logically separated each other, it is possible to use a physically same transmission line in common.

The display 28 and the access controller 29 at the user's home 26 are connected with the unit charge notification apparatus 33 in the charging system 30 via the price notification circuit 22. The terminal 27 is connected with the service facilities 24 via the access controller 29 and the telecommunication circuit 25.

The monitor 31 has a function for collecting, in real time, data which indicate, as a state of use of the service facilities 24, a load of the service facilities 21. The monitor 31 gives the collected data to the history database 35.

The state of load in the service facilities 24 is varied by the following factors.

(1) a capacity of the computer 24

(2) an access to the computer 24

(3) an amount of use of the communication circuit 25

(4) a transmission speed and a communication quality of the circuit 25 in connection

(5) a change of a service classification

The apparatus 32 decides, in real time, a unit charge pertinent to the state of load in the service facilities 24 based on the data indicating the load of the service facilities.

Namely, the apparatus 32 decides, in real time, the unit charge which is judged as a most pertinent value to the load of the service facilities 24, based on the data indicating the load of the facilities collected by the monitor 31, parameters of various kinds determined by a manager of the service facilities and the history data indicating a correlation between the unit charge already notified to the user and the load of the service facilities after having notified the unit charge. The decision of the unit charge is periodically performed and then the unit charge is changed in course of time.

The history database 35 stores and holds the history data i.e. the correlation between the unit charge already notified to the user and the state of the load in the service facilities after having notified the unit charge. The unit charge notified to the user is given to the data base 35 from the charging apparatus 34 and the state of the load in the service facilities after having notified the unit charge is given to the database 35 from the monitor 31.

The apparatus 33 has a function for sending, in real time, the unit charge decided by the apparatus 32 to the charging apparatus 34 and a function for notifying, in real time, the unit charge decided by the apparatus 32 to the display 28 and the access controller 29 at the user's home 26 via the price notification circuit 22. The charging apparatus 34 has a function for charging a service charge by using the transferred unit charge which varies in real time. The display 28 displays, always or according to a user's, the unit charge notified from the notification apparatus 33.

According to the unit charge notified from the apparatus 33 in the charging system 30, the access controller 29 automatically controls an access to the computer 24 in the service facilities 21 from the terminal 27 via the communication circuit 25.

The charging system 30 will be explained in detail including its initial value setting, the timer 36 and the console 37.

First, an operator of the service facilities sets an initial value of the unit charge in various information services and a guide line for a decision of the unit charge to the unit charge decision apparatus 32 by using the console 37. While it is necessary to perform these setting before start of the charging system 30, it is possible to change the setting after start of the system 30.

The unit charge decision apparatus 32 notifies the initial unit charge set by the operator to the unit charge notification apparatus 33. The apparatus 33 notifies the received initial unit charge to the charging apparatus 34 and the user's home 26. The charging apparatus 34 starts to charge by using the received unit charge.

On the other hand, at the user's home, the display 28 displays the notified unit charge for various kinds of an information service. Therefor, the user can look at the displayed unit charge on the display 28, then can access to the computer 24 in the service facilities 24 by using the communication circuit 25 after performing a selection of a service classification and/ or an adjustment of an amount of information according to his and/or her demand.

As another case, in the user's home 26, the access controller 29 automatically accesses the computer 24 after automatically performing a selection of a service classification and/ or an adjustment of an amount of information according to the notified unit charge.

The monitor 31 receives a trigger #1 from the timer 36. When the monitor 31 receives the trigger #1, the monitor 31 records the data indicating the state of the load in the service facilities, which was collected during a period F1 before receiving the trigger #1, in the history database 35. The timer 36 also sends the trigger #1 to the charging apparatus 34 at the same time when the timer 36 sends the trigger #1 to the monitor 31.

When the charging apparatus 34 receives the trigger #1, the apparatus 34 records the unit charge, which was used during a period F1 before receiving the trigger #1, in the history database 35.

As the result, the history database 35 holds the data indicating the state of the load in the service facilities and the unit charge respectively recorded during the period F1.

Furthermore, the timer 36 periodically sends a trigger #2 by a period F2 to the apparatus 32 for deciding the unit charge. When the apparatus 32 receives the trigger #2, the apparatus 32 downloads or reads the data indicating the state of load in the service facilities and the unit charge respectively recorded in the database 35 as the history data, and then decides a new unit charge in real time by using the history data. In detail of the decision of the new unit charge, the apparatus 32 predicts the user's elasticity of access demand depending on a cost, based on the correlation between the data indicating the state of the load in the service facilities and the past unit charge respectively recorded as the history data. The apparatus 32 decides, by using the result of the prediction, the new unit charge which enables to estimate an occurrence of an amount of access demand pertinent to the capacity of the service facilities.

The new unit charge decided by the apparatus 32 is transferred to the price notification apparatus 33, then the apparatus 33 immediately notifies the new unit charge to the charging apparatus 34 and the user's home 26.

The charging apparatus 34 starts to charge by using the notified new unit charge. In detail, because it is necessary to use a unit charge which has been recognized by the user, the charging apparatus 34 changes a unit charge to be used to the new unit charge at a timing which is set by considering a time delay required to notify the new unit charge to the user.

By repeating the above-mentioned process, the unit charge is periodically varied and set to the value pertinent to an amount of access to the service facilities, therefor an amount of access demand pertinent to the capacity of the facilities is applied to the service facilities 21.

The period F1 and the period F2 are set by the operator of the service facilities by using the console 37. Basically, the period F1 and the period F2 are set as F1≦F2. It is possible to change, always such as during an operation of the charging system 30, each value of the period F1 and the period F2.

Further, it is possible that the monitor 31, instead of the timer 36, sends the trigger #1 and the trigger #2 according to a content of the data indicating the state of the load in the service facilities.

In this case, it is desirable to construct the information service system so that the operator of the service system can send the trigger 41 and the trigger #2 when the data indicating the state of the load in the service facilities becomes to a certain specific state. It is also possible to use both of the trigger sent from the timer 36 and the trigger sent from the monitor 31.

### Fifth Embodiment

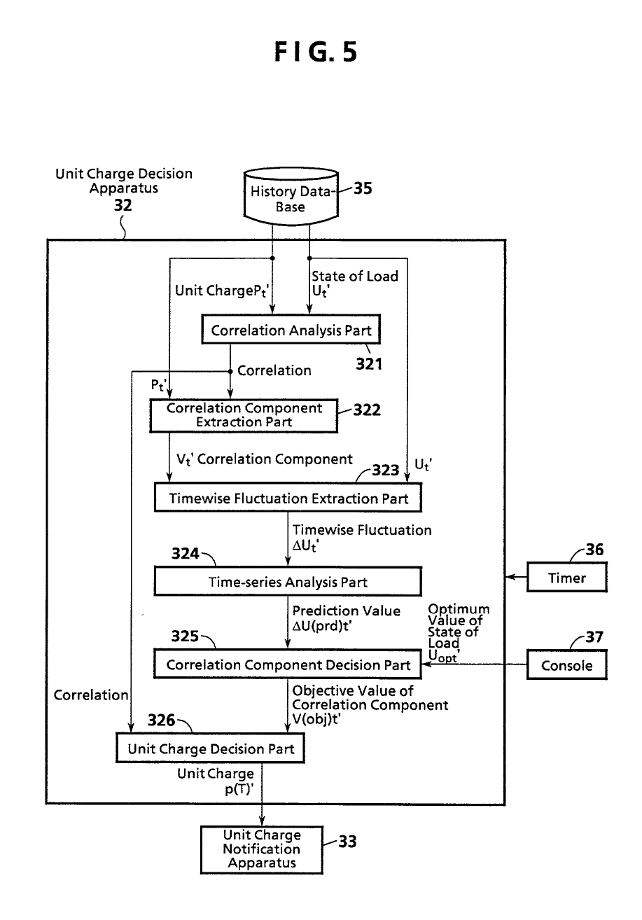

Referring to FIG. 5, as a fifth embodiment of the present invention, an example of the unit charge decision apparatus or the apparatus for deciding the unit charge which is used the charging system regarding the service for providing information, will be explained. FIG. 5 shows an example of a functional configuration of the unit charge decision apparatus. It is assumed that the unit charge decision apparatus shown in FIG. 5 is used in the charging system 30 shown in FIG. 4.

In FIG. 5, the unit charge decision apparatus 32 comprises: a correlation analysis part 321; a correlation component extraction part 322; a timewise fluctuation extraction part 323; a time-series analysis part 324; a correlation component decision part 325; and a unit charge decision part 326.

In this embodiment, it is assumed that the trigger #2 shown in FIG. 4 is periodically sent from the timer 36 to the apparatus 32 for deciding the unit charge. In the case that the trigger #2 is sent from the monitor 31, while an interval of the trigger is not uniform, the basic operation is same to the above.

In FIG. 5, the timer 36 periodically sends the trigger #2 in the period F2 to the apparatus 32 for deciding the unit charge. Further, it is assumed a condition that the T-th trigger #2 has been sent to the apparatus 32. Namely, it is assumed that a time of F2×T has lapsed after the apparatus 32 started its operation.

In the apparatus 32, when the trigger #2 is received, the part 321 downloads the history data from the history database 35 for analyzing a correlation for the data indicating the state of load in the service facilities and the unit charge. The data to be downloaded are a time-series data of the unit charge and a time-series data of the data indicating the state of te load in the service facilities respectively recorded every period F1 during the time of F2×T after the start of the charging system 30. Wherein, Pt′ represents the unit charge recorded according to the t-th trigger #1 and Ut′ represents the data indicating the state of load in the service facilities recorded according to the t-th trigger #1. Further, the history data downloaded according to the T-th trigger #2 includes the unit charge Pt′ and the data Ut′, wherein all of t satisfies the following formula.

0<F1×t<F2×T

The part 321 has a function for performing a correlation analysis between the unit charge Pt′ and the data Ut′ regarding all of t and for obtaining a correlation between the unit charge Pt′ and the data Ut′.

The part 322 has a function for extracting, based on the correlation obtained by the part 321, a correlation component Vt′ of the data Ut′ against the unit charge Pt′ regarding all of t.

The part 323 has a function for extracting a timewise fluctuation component ΔUt′ by subtracting the correlation component Vt′ from the data Ut′ regarding all of t.

The part 324 has a function for predicting a timewise fluctuation component ΔUt′, which will occurs until the timer 36 will send the next (T+1)-th trigger #2, by performing a time-series analysis of the timewise fluctuation component. Namely, when a prediction value of ΔUt′ is assumed as ΔU(prd)t′, the part 324 has a function for obtaining the prediction value ΔU(prd)t′ of the timewise fluctuation component regarding all of t which satisfies the following formula.

F2×T≦F1×t<F2×(T+1)

The part 325 has a function for deciding an object value V(obj) t′ by deleting the prediction value ΔU(prd)t′ from an optimum value Vopt′ of the data indicating the state of load in the service facilities regarding all of t which satisfies the following formula.

F2×T≦F1×t<F2×(T+1)

The optimum value Vopt′ represents an ideal state of load pertinent to the capacity of the service facilities. The operator of the service facilities sets the optimum value Vopt′ by using the console 37, wherein the setting of the optimum value Vopt′ can be changed, always such as during the operation of the charging system 30, by using the console 37.

As the result, if the timewise fluctuation component ΔUt′ coincides with its prediction value ΔU(prd)t′, the data Ut′ indicating the state of the load in the service facilities becomes the ideal correlation component Vt′ which realizes the optimum value Vopt′.

The part 326 has a function for deciding, based on the correlation between the data Ut′ and the data Pt′ obtained by the correlation analysis part 321, the unit charge P(T)′ to be used until receiving the (T+1)-th trigger #2 from the object value V(obj)t′ regarding all of t which satisfies the following formula.

F2×T≦F1×t<F2×(T+1)

The unit charge P(T)′ is sent from the unit charge decision apparatus 32 to the unit charge notification apparatus 33. Further, the unit charge P(T)′ is notified to the charging apparatus 34 and the user's home 26 by the unit charge notification apparatus 33.

According to above-mentioned process of each of the functional parts 221 to 226, it is possible for the unit charge decision apparatus 32 to periodically change the unit charge in real time or in course of time and to set the unit charge as the value which enables to awaken the amount of the access demand pertinent to the capacity of the service facilities.

### Sixth Embodiment

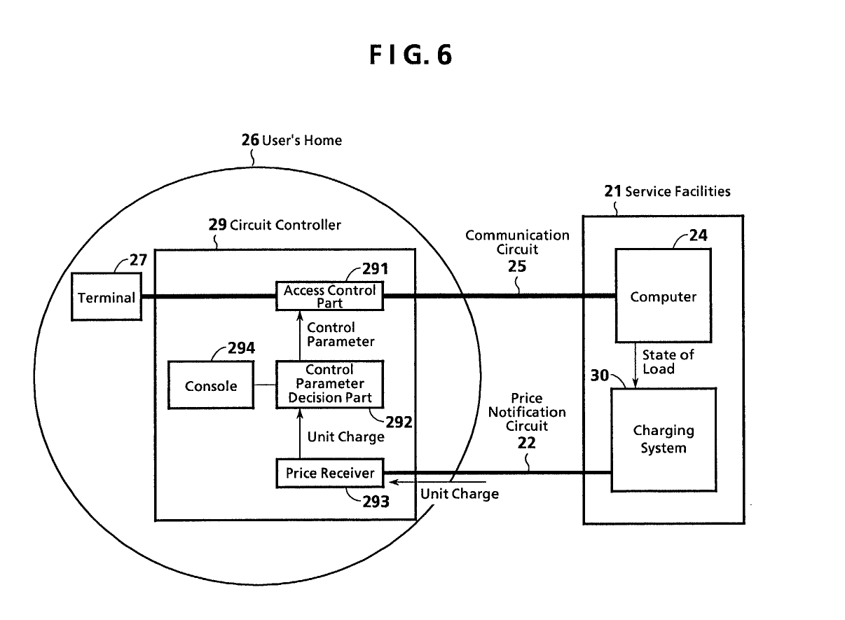

Referring to FIG. 6, as a sixth embodiment of the present invention, an example of the access control apparatus or the access controller regarding the service for providing information, will be explained. FIG. 6 shows an example of a functional configuration of the access control apparatus.

As shown in FIG. 6, the access control apparatus 29 comprises: a access control part 291; a control parameter decision part 292; a price receiving part 293; and a console part 294.

In FIG. 6, the new unit charge is periodically notified to the price receiver 293, via the price notification circuit 22, from the charging system 30. The receiver 293 has a function for receiving the notified unit charge and a function for transferring the received unit charge to the control parameter decision part 292.

The control parameter decision part 292 has a function for deciding various kinds of parameters of service for providing information based on the notified unit charge and a function for transferring the decided parameter value to the circuit control part 291. As the parameter to be decided, there are a setting of an access, a judgment of open of the access, a transmission speed, a quality of the communication circuit and a service classification etc.

The user previously sets steps for deciding the various parameters based on the unit charge by using the console 294. The setting of these parameter can be changed, always such as during the operation of the charging system 30, by using the console 94.

The access control part 291 has a function for performing a change and/or an adjustment of the speed of the communication circuit 25 to be used by the terminal 27, the quality of the communication and the service classification respectively according to the received parameter values and further has a function for controlling the access to the computro24 respectively according to the received parameter values.

According to above-mentioned process of each of the functional parts 291 to 294, the access control apparatus 29 automatically enables to use the service facilities 21 for providing information in a manner desired by the user itself, for example to economically use the service facilities 25, by controlling the access according to the notified unit charge based on a control guide line previously set by the user.

According to the charging system in the communication network facilities of the the present invention, it is possible to always awaken an amount of a communication demand corresponding to a capacity of the communication network facilities by setting the unit charge pertinent to a communication service of which prediction of demand is difficult and/or a communication service of which demand largely fluctuates in course of time. Further, it is possible to stabilize a service quality of communication against a sudden fluctuation of a communication demand and it is also possible to stabilize earings and to avoid a decrease in income based on a prediction error against the user's elasticity of communication demand depending on a cost.

According to the apparatus for deciding a unit charge in the communication network facilities of the the present invention, it is possible to always set the unit charge pertinent to a communication service of which prediction of demand is difficult, a communication service of which demand largely fluctuates in course of time and/or a sudden fluctuation of the amount of the communication demand.

According to the unit charge display apparatus in the communication network facilities of the the present invention, because the apparatus displays the unit charge according to the amount of the communication demand, it is possible for user to use the communication service in user's desired manner by looking at the displayed unit charge.

According to the circuit control apparatus of the the present invention, it is possible to automatically connect the communication circuit in a desired manner according to the unit charge.

According to the charging system in the service facilities of the the present invention, it is possible to always awaken an amount of a service demand corresponding to a capacity of the service facilities by setting the unit charge pertinent to a service of which prediction of access demand is difficult and/or a service of which access demand largely fluctuates in course of time. Further, it is possible to stabilize a service quality against a sudden fluctuation of an access demand and it is also possible to stabilize earings and to avoid a decrease in income based on a prediction error against the user's elasticity of demand depending on a cost.

According to the apparatus for deciding a unit charge in the service facilities of the the present invention, it is possible to always set the unit charge pertinent to a service of which prediction of access demand is difficult, a service of which access demand largely fluctuates in course of time and/or a sudden fluctuation of the amount of the access demand.

According to the unit charge display apparatus in the service facilities of the the present invention, because the apparatus displays the unit charge according to the amount of the access demand, it is possible for user to use the service in user's desired manner by looking at the displayed unit charge.

According to the access control apparatus of the the present invention, it is possible to automatically access the service for providing information in a desired manner according to the unit charge.

The invention being thus described, it will be apparent that the same may be varied in many ways. Such variations are not to be regarded as a departure from the spirit and scope of the invention, and all such modifications as would be obvious to one skilled in the art are intended to be included within the scope of the following claims.

We claim:

1. A charging system comprising:
first means for notifying, via a communication circuit, a subscriber of a unit charge which is varied in course of time and for charging a communication charge which is a charge for using a communication network facilities based on said unit charge notified to the subscriber;
second means for monitoring, after notifying said unit charge, a state of use of the communication network facilities;
third means for recording a correlation between said unit charge already notified to the subscriber and said state of use of the communication network facilities after having notified said unit charge; and
fourth means for deciding a new unit charge based on said correlation between the unit charge already notified to the subscriber and the state of use of the communication network facilities after having notified the unit charge.

2. A communication network system having a charging system, wherein said charging system comprises:
first means for notifying, via a communication circuit, a subscriber of a unit charge which is varied in course of time and for charging a communication charge which is a charge for using a communication network facilities based on said unit charge notified to the subscriber;
second means for monitoring, after notifying said unit charge, a state of use of the communication network facilities;
third means for recording a correlation between said unit charge already notified to the subscriber and said state of use of the communication network facilities after having notified said unit charge; and
fourth means for deciding a new unit charge based on said correlation between the unit charge already notified to the subscriber and the state of use of the communication network facilities after having notified the unit charge.

3. The network system claimed in claim 2, wherein said fourth means decides said new unit charge by using time-series data of said unit charge already notified to the subscriber, time-series data of said state of use of the communication network facilities and correlation data between the unit charge already notified to the subscriber and the state of use of the communication network facilities after having notified the unit charge.

4. The network system claimed in claim 2, wherein said fourth means includes:
a correlation analysis part for performing an analysis of a correlation between the unit charge and the data indicating the state of use of the communication network facilities;
a correlation component extraction part for extracting, based on said analyzed correlation, a correlation component of the data indicating the state of use of the communication network facilities against the unit charge;
a timewise fluctuation extraction part for extracting a fluctuation component in course of time from said extracted correlation component and the data indicating the state of use of the communication network facilities;
a time-series analysis part for predicting a fluctuation component in course of time by performing a time-series analysis of said extracted fluctuation component in course of time;
a correlation component decision part for deciding an object value by deleting said predicted fluctuation component from an optimum value indicating an ideal state of use of the communication network; and
a unit charge decision part for deciding the unit charge based on said analyzed correlation and said decided object value.

5. The network system claimed in claim 2, further having a display apparatus connected with said communication network facilities, wherein said display apparatus is notified said unit charge from said charging system and displays said notified unit charge.

6. The network system claimed in claim 2, further having a circuit control apparatus connected with said communication network facilities, wherein said circuit control apparatus is notified said unit charge from said charging system and performs a setting and an open of a communication circuit between a communication terminal and said communication network facilities based on said unit charge notified from said charging system.

7. The network system claimed in claim 6, wherein said circuit control apparatus includes:
a price receiving part for receiving the notified unit charge;
a console part for setting a guide line which is used for deciding a control parameter of the communication circuit;
a control parameter decision part for deciding a control parameter based on said received unit charge and said guide line; and
a circuit control part for performing a setting and an open of the communication circuit according to said decided control parameter.

8. A service system for providing information having a charging system, wherein said charging system comprises:
first means for notifying, via a communication circuit, a user of a unit charge which is varied in course of time and for charging a service charge which is a charge for using a service facilities for providing information based on said unit charge notified to the user;
second means for monitoring, after notifying said unit charge, a state of use of the service facilities;
third means for recording a correlation between said unit charge already notified to the user and said state of use of the service facilities after having notified said unit charge; and
fourth means for deciding a new unit charge based on said correlation between the unit charge already notified to the user and the state of use of the service facilities after having notified the unit charge.

9. The service system claimed in claim 8, wherein said fourth means decides said new unit charge by using time-series data of said unit charge already notified to the user, time-series data of said state of use of the service facilities and correlation data between the unit charge already notified to the user and the state of use of the service facilities after having notified the unit charge.

10. The service system claimed in claim 8, wherein said fourth means includes:
a correlation analysis part for performing an analysis of a correlation between the unit charge and the data indicating the state of use of the service facilities;
a correlation component extraction part for extracting, based on said analyzed correlation, a correlation component of the data indicating the state of use of the service facilities against the unit charge;
a timewise fluctuation extraction part for extracting a fluctuation component in course of time from said extracted correlation component and the data indicating the state of use of the service facilities;
a time-series analysis part for predicting a fluctuation component in course of time by performing a time-series analysis of said extracted fluctuation component in course of time;
a correlation component decision part for deciding an object value by deleting said predicted fluctuation component from an optimum value indicating an ideal state of use of the communication network; and
a unit charge decision part for deciding the unit charge based on said analyzed correlation and said decided object value.

11. The service system claimed in claim 8, further having a display apparatus connected with said service facilities, wherein said display apparatus is notified said unit charge from said charging system and displays said notified unit charge.

12. The service system claimed in claim 8, further having an access control apparatus connected with said service facilities, wherein said access control apparatus is notified said unit charge from said charging system and controls an access to said service facilities from a communication terminal based on said unit charge notified from said charging system.

13. The service system claimed in claim 12, wherein said access control apparatus includes:
a price receiving part for receiving the notified unit charge;
a console part for setting a guide line which is used for deciding an access control parameter;
a control parameter decision part for deciding an access control based on said received unit charge and said guide line; and
a access control part for controlling the access to the service facilities according to said decided parameter.
